(19) United States
(12) Patent Application Publication
(10) Pub. No.: US 2026/0358579 A1
(43) Pub. Date: Nov. 12, 2026

(54) FIBER-TO-CHIP SELF-ALIGNMENT

(71) Applicants: CORNING INCORPORATED, CORNING, NY (US); UNIVERSIDADE ESTADUAL DE CAMPINAS WITH THE ADMINISTRATIVE INTERVENTION OF FUNDA, Campinas (BR)

(72) Inventors: Thiago Pedro Mayer Alegre, Campinas (BR); Chams Baker, Corning, NY (US); Paulo Clovis Dainese, JR., Painted Post, NY (US); Seyyed Ali Hassani Gangaraj, Ithaca, NY (US); Paulo Felipe Jarschel de Siqueira, Campinas (BR); Leticia de Sousa Magalhaes, Cambridge, MA (US); Gustavo Wiederhecker, Jaguariúna (BR)

(21) Appl. No.: 19/664,143

(22) Filed: Apr. 30, 2026

Related U.S. Application Data
(60) Provisional application No. 63/800,688, filed on May 6, 2025.

(51) Int. Cl. G02B 6/42; G02B 6/02; G02B 6/245; G02B 6/25

(52) U.S. Cl. CPC G02B 6/4228; G02B 6/02295; G02B 6/245; G02B 6/25; G02B 6/4239; G02B 6/424

(57) ABSTRACT

A method and system for optical coupling between a fiber and a photonic waveguide using optical forces for self-alignment. The system includes a tapered optical fiber positioned adjacent to a photonic waveguide, where optical forces enable alignment without active control systems. The fiber is implemented as either a nanotip with single-anchor design or a double-anchored taper configuration. Attractive forces between the waveguide and fiber enable self-alignment for offsets of 1-2 μm using moderate optical power around 50 mW. Various implementations include suspended waveguides, substrate-mounted configurations, and systems embedded in low-index materials.

### CROSS REFERENCE TO RELATED APPLICATION

This application claims the benefit of priority under 35 U.S.C. § 119 of U.S. Provisional Application Ser. No. 63/800,688 filed on May 6, 2025, the content of which is relied upon and incorporated herein by reference in its entirety.

### BACKGROUND

The development of photonic integrated devices has experienced substantial growth over the past decade, with significant advances enabling new on-chip functionalities including lasing, photodetection, and radio-frequency signal generation. However, while the compact footprint of chips with such photonic devices is advantageous for a number of reasons, it presents significant challenges for coupling light into and out of these chips. Many communications applications have parameters to achieve, such as low loss, large bandwidth and polarization insensitivity, to enable a low cost and scalable platform. In quantum applications, losses can fundamentally disrupt quantum state transferring, imposing extremely stringent coupling loss parameters. Unfortunately, current approaches to address low loss coupling challenges are generally unable to meet the stringent parameters for alignment.

### BRIEF DESCRIPTION OF THE FIGURES

The drawings illustrate generally, by way of example, but not by way of limitation, various aspects of the present invention.

FIG. 1A shows an optical fiber nanotip, according to some embodiments.

FIG. 1B shows an optical fiber taper, according to some embodiments.

FIG. 1C shows light coupling evanescently from the nanotip of FIG. 1A into a waveguide, according to some embodiments.

FIGS. 2A-2C illustrate a coupled fiber-waveguide system, according to some embodiments.

FIGS. 3A-3D illustrate a symmetric electric field distribution of the coupled fiber-waveguide system, according to some embodiments.

FIG. 4 illustrates vertical polarization (TM) insertion loss of the coupled fiber-waveguide system, according to some embodiments.

FIGS. 5A and 5B respectively illustrate a cross section view and forces of the coupled fiber-waveguide system, according to some embodiments.

FIGS. 6A-6E illustrate horizontal polarization insertion loss versus wavelength and the corresponding electric field distribution of the coupled fiber-waveguide system, according to some embodiments.

FIGS. 7A and 7B respectively illustrate a cross section view and forces of the coupled fiber-waveguide system, according to some embodiments.

FIG. 8A illustrates cross section views of fiber tips, according to some embodiments.

FIG. 8B illustrates the effective index difference of the fiber tips shown in FIG. 8A, according to some embodiments.

FIG. 9 illustrates the taper and nanotip profiles limited by the adiabaticity criteria, according to some embodiments.

FIG. 10 illustrates taper measurements, according to some embodiments.

FIG. 11 illustrates taper profile and displacement, according to some embodiments.

FIGS. 12A and 12B respectively illustrate nanotip deflection and stiffness, according to some embodiments.

FIG. 13 illustrates optical force, according to some embodiments.

FIGS. 14A-14F illustrates coupled fiber-waveguide systems, according to some embodiments.

FIG. 15 illustrates a method of fabricating the coupling system, according to some embodiments.

FIGS. 16A and 16B respectively illustrate compliance maps for an exponential nanotip with different compliances, according to some embodiments; FIGS. 16C and 16D respectively illustrate compliance maps for a triangular nanotip different compliances, according to some embodiments.

FIG. 17 illustrates a block diagram of an example electronic device, according to some embodiments.

### DETAILED DESCRIPTION OF THE INVENTION

Reference will now be made in detail to certain aspects of the disclosed subject matter. While the disclosed subject matter will be described in conjunction with the enumerated claims, it will be understood that the exemplified subject matter is not intended to limit the claims to the disclosed subject matter.

As above, alignment issues, particularly as related to photonic integrated devices (PIDs), are unable to be resolved using current coupling approaches, which include grating couplers, lensed fiber assisted edge coupling, and evanescent coupling. Grating couplers offer relatively robust alignment tolerance but suffer from narrow frequency bandwidth, polarization dependence and high insertion losses (typically larger than 3 dB), unless special mirror layers are employed in the photonic chip design. Butt-coupling and evanescent coupling schemes may be able to achieve high bandwidth with low insertion losses (sub-dB insertion losses and bandwidths exceeding 200 nm). However, the sub-micrometer alignment tolerance to integrated waveguides is difficult to achieve in scaling butt-couplers and evanescent couplers. Dedicated computer vision systems or active alignment may be used to attain submicron-scale fiber positioning, which significantly restricts scalability and lacks a clear path toward cost-effective solutions. Moreover, the use of computer vision and active alignment, while feasible in specialized research laboratory environments, become problematic in commercial implementations as well as under more stringent conditions or with limited optical access, such as inside cryostats or dilution fridges used in photonic quantum computing implementations. Similarly, control of lateral offsets between the optical fiber and the waveguide for butt-coupling control is exceedingly difficult, while control of both lateral offset and the vertical gap between the top and bottom waveguides for evanescent couplers presents an even greater challenge.

For multi-mode fibers, alignment typically is desired to be within one or two microns, while single-mode fibers use alignment within 0.1 micrometers for optimal low loss coupling. This precision stems from the small size of waveguides, which are typically 220 nanometers by 500 nanometers. Note that while silicon waveguides are described, other materials may be used, such as silicon nitride, silicon dioxide, lithium niobate and others. While active alignment systems with feedback loops that measure coupled light output and adjust fiber positioning in real-time may be used to maintain optimal coupling efficiency, the systems and methods disclosed herein reduce the relative complexity and cost of such coupling.

Moreover, passive alignment or active alignment can be used with different coupling schemes using gratings, lens-assisted edge coupling or evanescent couplers. Passive alignment, however, suffers from high loss as it may be difficult to ensure submicron positioning. Active alignment, as above, uses complex setups to provide fast submicron active positioning and some sort of feedback (either vision or measuring the coupled power).

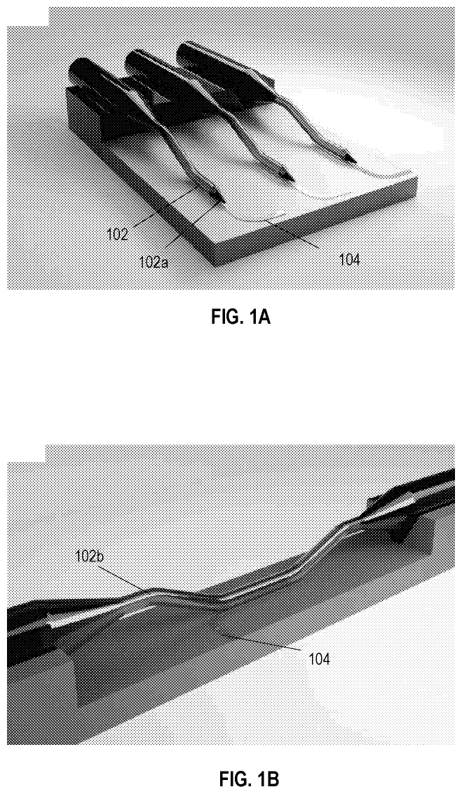

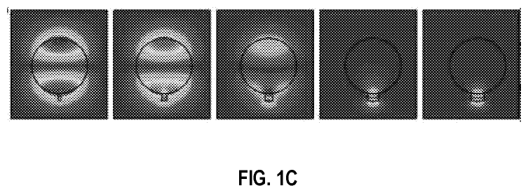

Optical forces may, in some embodiments, be used to alleviate strict alignment precision for evanescent coupling schemes without the use of an active control system. In other embodiments, optical forces may be used to supplement active control by using the passive alignment (optical forces) only after bringing the optical fiber in proximity to a target (e.g., a waveguide or another optical fiber). As used herein, proximity is less than about 5 μm, preferably less than about 1 μm. The active control system may include a mechanical manipulator controlled by a processor that uses optical feedback to determine the proximity between the optical fiber and the target. To this end, FIGS. 1A-1C show example embodiments of an optical fiber, use, and fabrication according to some embodiments in which FIG. 1A shows an optical fiber nanotip, FIG. 1B shows an optical fiber taper, and FIG. 1C shows light coupling evanescently from the nanotip of FIG. 1A into a waveguide. In FIG. 1A, an optical fiber 102 with a nanotip 102a is brought near but not exactly aligned to a target photonic waveguide 104 (which may be, for example, 220 nm by 500 nm). At close distance, the optical force between the nanotip 102a and the photonic waveguide 104 becomes strong enough to induce self-alignment within about 50 nm for low loss. Physically, the nanotip 102a is attracted towards the waveguide 104. In FIG. 1B, a nanotip 102b is used that is anchored at both ends and has a middle section that bends towards the photonic waveguide 104. In FIG. 1C, which shows cross-sectional areas along the nanotip 102a, the light couples evanescently from the nanotip 102a into the rectangular photonic waveguide 104 disposed under the nanotip 102a as the images progress from left to right. A batch process may be used to fabricate the nanotips 102b by chemically etching the cladding of the optical fiber. In this case, the optical fiber cladding is etched at a higher rate than the core, thereby forming a tapered fiber as the images progress from left to right.

The additional degree of freedom created by optical forces can be effective to enable self-alignment in a highly efficient, broadband and polarization insensitive configuration. In particular, the mutual optical force between the tapered optical fiber and waveguide is attractive under either symmetric transverse electric (TE) or transverse magnetic (TM) optical mode excitation. The magnitude of the force is sufficient to attract the position of the optical fiber towards the top of the underlying waveguide, at which point the optical fiber is able to be fixed in place with an adhesive. The coupling is effectively wideband, having a bandwidth of greater than about 250 nm at a light wavelength of 1.55 μm and has a relatively low insertion loss of less than about 0.5 dB, in addition to being polarization insensitive. The optical force alignment technique described herein achieves the same high performance as passive and active alignment techniques without encountering issues of such techniques, including use of a complex positioning system and active monitoring. As described herein, the optical force alignment technique uses a laser, whose beam is injected into one end of a tapered optical fiber. The taper of the optical fiber self-aligns to the top of the photonics waveguide due to the mutual attractive optical force as the laser beam couples from fiber to waveguide, at which point the position of the taper is fixed with an adhesive.

In more detail, both low loss and large optical forces should be achieved simultaneously by the system design. Low loss herein includes low loss for specific bandwidths and for both polarization states (TE and TM). The optical forces include both strength and range. The strength of the optical forces is to be sufficient to move and deflect the taper (or the nanotip) towards the top of the target waveguide, while the range indicates how far from the waveguide the optical force starts to have a significant role. For a passive alignment system with few microns of accuracy, the optical forces are to be sufficiently large to induce self-alignment. Both the loss and optical forces are determined by the geometries and refractive indices in the coupling region.

Electromagnetic analysis using Finite-Difference-Time-Domain (FDTD) simulations is provided for a system in which the region between the taper and the photonic waveguide is air. From the FDTD results, both coupling efficiencies as well as optical forces obtained through the integration of the Maxwell Stress Tensor around the fiber are extracted and presented. Note that in addition to the specific embodiments described herein, other configurations may be used, for example configurations in which a non-air cladding medium is used that has a lower refractive index than the refractive index of the fiber.

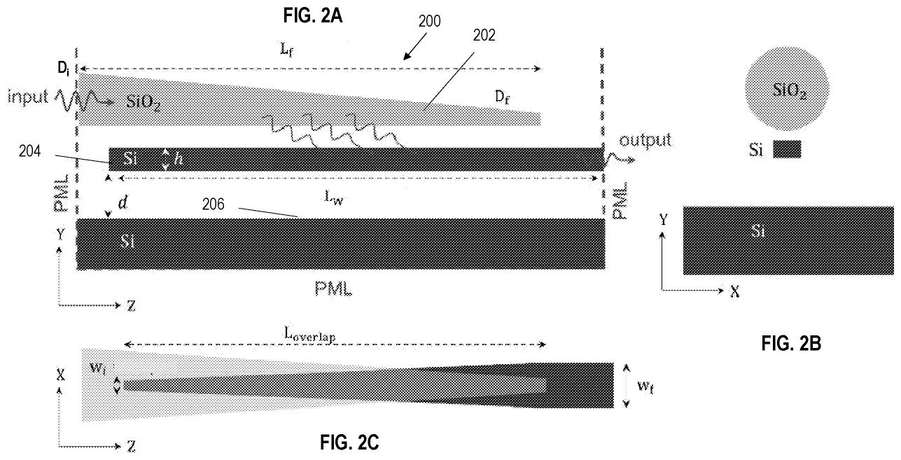

FIGS. 2A-2C illustrate a coupled fiber-waveguide structure, according to some embodiments. FIG. 2A illustrates a side view of the system 200, FIG. 2B illustrates a cross-section view of the system 200, and FIG. 2C illustrates the top view of the tapered fiber and waveguide of the system 200. The system 200 contains a tapered optical fiber 202 on top of a silicon (Si) waveguide 204 and a silicon substrate 206 where the open boundaries of the system 200 are modeled as a perfectly matched layer (PML). The waveguide 204 may have a substantially uniform shape or may be tapered towards the optical fiber 202. The tapered waveguide 204 may taper in width (direction x) but not height such that a distance between the waveguide 204 and the optical fiber 202 in a height direction (i.e., direction y) remains substantially identical along a length (i.e. direction z) of the waveguide. Independent of whether the waveguide 204 is tapered, the axis of the optical fiber 202 aligns with the axis of the waveguide 204 (i.e., overlaps in the y direction/both the propagation and transverse directions).

As shown in FIG. 2A, light from the optical fiber 202 evanescently couples into the waveguide 204 over the length of the optical fiber 202. The cladding between the optical fiber 202 and the waveguide 204 is air. The waveguide 204 and a silicon substrate 206 are separated by a distance d (e.g., 3 μm), with the waveguide 204 being above the substrate 206. The optical fiber 202 is tapered such that the diameter of the optical fiber 202 decreases linearly from an initial diameter (Dᵢ) to a final diameter (D_{f}) over the length of the taper (L_{w}), where Dᵢ=1.7 μm, D_{f}=0.2 μm, and L_{w}=122.5 μm, in the embodiment shown in FIG. 2A. The height (h) of the waveguide 204 in FIG. 2A is h=0.25 μm and the width of the waveguide 204 may linearly increase from an initial width (wᵢ) to a final width (w_{f}), where wᵢ=0.1 μm and w_{f}=0.3 μm over the length L_{w}. The optical fiber 202 and the waveguide 204 overlap over a length Lₒᵥₑᵣₗₐₚ of 120 μm as shown in FIG. 2C. The dimensions in FIGS. 2A-2C, while optimized to provide high coupling efficiency for the specific system, are merely exemplary and may be different dependent on the various materials and shapes used. Although linear tapers are described, the tapers may be of other shapes, such as a curved or stepwise shape, may be used in other embodiments. Similarly, although the taper is shown as extending along the entire length of the optical fiber from the initial portion of the taper to the nanotip, in some embodiments, the taper may terminate at an intermediate point and extend in a uniform diameter to the end of the nanotip.

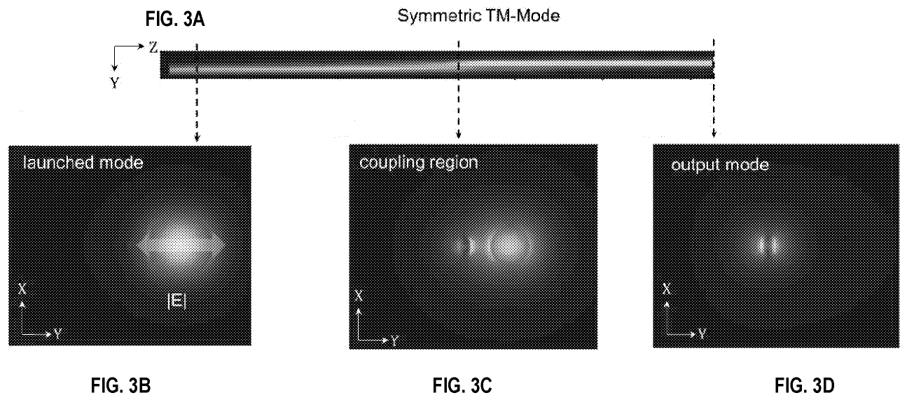

FIGS. 3A-3D illustrate a symmetric electric field distribution of the coupled fiber-waveguide system, according to some embodiments. FIG. 3A illustrates a side view of the symmetric TM electric field distribution, while FIGS. 3B-3D illustrate cross section views of the symmetric TM mode distribution of the coupled fiber-waveguide system at the points indicated in FIG. 3A. As shown in FIG. 3A, light is launched through the left side of the optical fiber and is coupled into the waveguide as the light propagates along the z-axis toward the right. The light has a wavelength of 1.55 μm, although other wavelengths may be used. The white double arrow in FIG. 3B indicates the launched mode polarization (symmetric TM mode), specifically the simulations are shown at the launch point (FIG. 3B), coupling region (FIG. 3C), and output (FIG. 3D). As can be seen, the TM mode is confined to the fiber in FIG. 3B. However, as the light propagates, the light is gradually coupled into the waveguide as shown in FIGS. 3C and 3D, eventually appearing as the symmetric mode of the waveguide at the end of the system in FIG. 3D. For this simulation, the gap size (d_{g}) between the fiber and the waveguide is 0.5 μm.

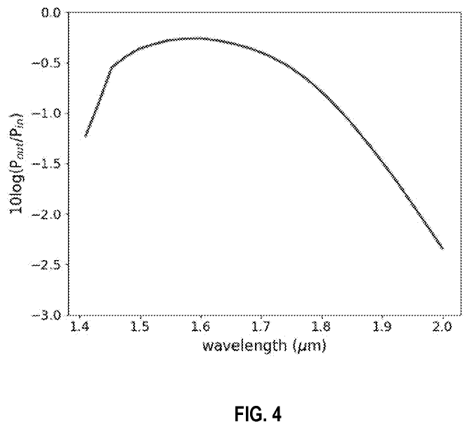

FIG. 4 illustrates vertical polarization (TM) insertion loss of the coupled fiber-waveguide system, according to some embodiments. In particular, FIG. 4 shows a simulation of the wide band insertion loss for symmetric TM mode for a gap size between the fiber and the waveguide of 0.5 μm. Although the operational bandwidth depends on the size of the gap, as shown in the graph of FIG. 4 the system provides low insertion loss for wavelengths in the range from about 1.45 μm to about 1.73 μm.

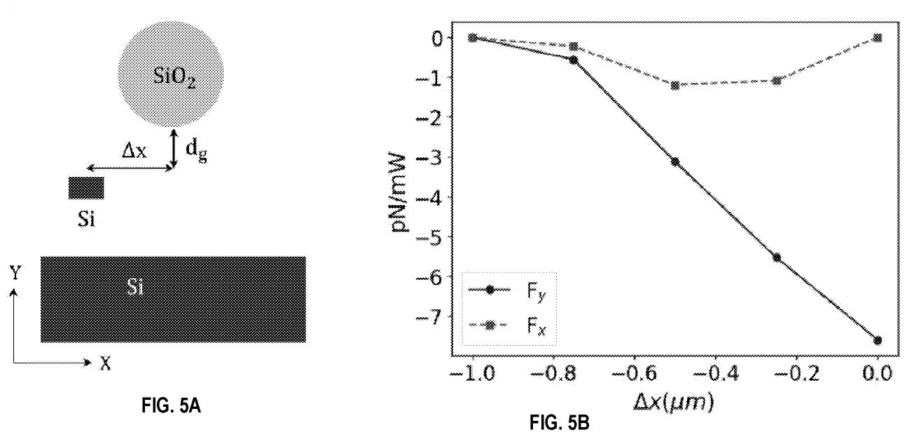

FIGS. 5A and 5B respectively illustrate a cross section view and forces of the coupled fiber-waveguide system, according to some embodiments. The cross-section view of the coupled tapered fiber and waveguide system demonstrated in FIG. 2. To calculate the optical force, the waveguide is incrementally moved away from the coordinate center along the x-axis (Δx) with a constant gap size (d_{g}) from the tapered fiber as shown in FIG. 5A. As shown in FIG. 5A, the tapered fiber overlaps the waveguide in the propagation direction but not the transverse direction. At each Δx value, the vertical and horizontal forces are calculated by integrating the Maxwell Stress Tensor on a closed surface enclosing only the fiber. The results are shown in FIG. 5B. As can be seen, the mutual vertical and horizontal forces are negative, which means there exists an attractive force that tends to pull together the fiber and the waveguide. This force is used in the mechanical simulations below to compute the mechanical deflection of the fiber tip.

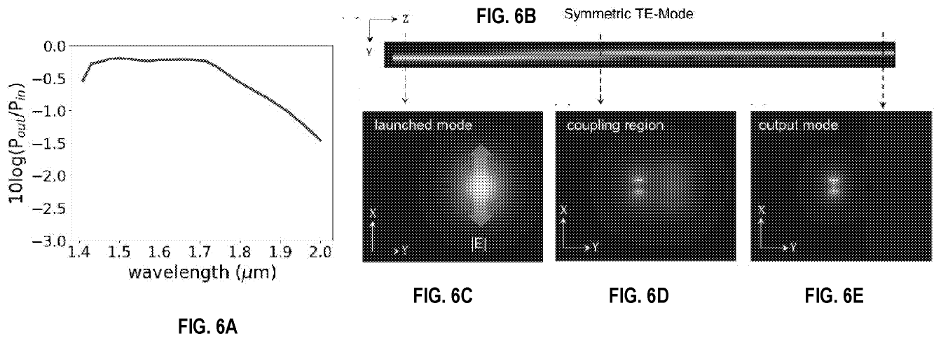

FIGS. 6A-6E illustrate horizontal polarization insertion loss versus wavelength and the corresponding electric field distribution of the coupled fiber-waveguide system, according to some embodiments. FIG. 6A illustrates symmetric TE polarization insertion loss versus wavelength for a gap size between the fiber and the waveguide of 0.5 μm. As shown in FIG. 6A, the system provides low insertion loss for wavelengths in the range from about 1.49 μm to about 1.72 μm. FIG. 6B illustrates a side view of the symmetric TE electric field distribution at a wavelength of 1.55 μm, while FIGS. 6C-6E illustrate cross section views of the symmetric TE mode field distribution of the coupled fiber-waveguide system at the points indicated in FIG. 6B, specifically at the launch point (FIG. 6C), coupling region (FIG. 6D), and output (FIG. 6E). The TE operational bandwidth overlaps the TM mode, indicating polarization insensitivity of the coupled fiber-waveguide system.

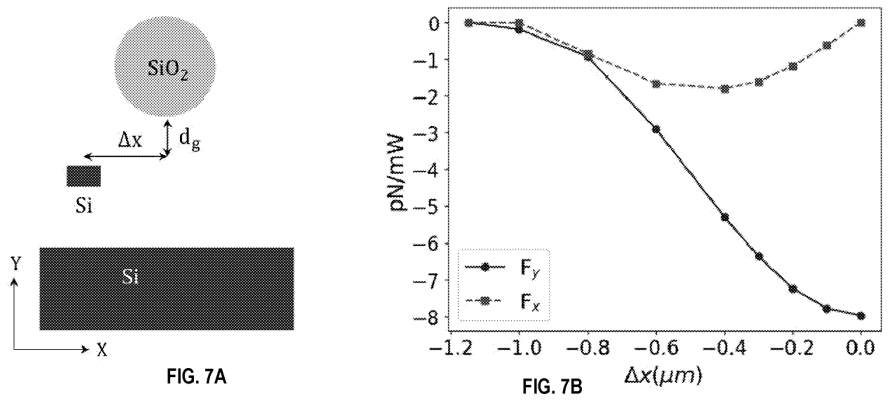

FIGS. 7A and 7B respectively illustrate a cross section view and forces of the coupled fiber-waveguide system, according to some embodiments. Similar to the cross section view and forces of the coupled fiber-waveguide system for TM mode, the waveguide is moved away from the coordinate center along the x-axis (Δx) with a constant gap size (d_{g}) from the tapered fiber as shown in FIG. 7A. At each Δx value, the vertical and horizontal forces are calculated and shown in FIG. 7B. Similar to FIG. 5B, the mutual vertical and horizontal forces are negative, which means that under symmetric TE excitation, an attractive force exists that tends to attract waveguide to the fiber. The optical forces for both TE and TM have similar magnitudes.

The mechanical design of the coupling structure involves multiple challenges. For example, the shape of the nanotip is engineered to induce proper evanescent coupling, which involves low optical loss and at an adiabatic condition in which the wave properties, particularly amplitude and phase, change very gradually over space, allowing for a smooth transition without significant disruption or excitation of other modes. In addition, the stiffness of the shape of the nanotip is designed to be low enough to move and bend under the action of the optical forces sufficiently to enable coupling to the waveguide. The impact of undesired electromagnetic forces, such as those arising from electrostatic and Van der Walls interaction, as well as from viscous forces in the surrounding medium (which could be air or an index matching resin) is also taken into account in designing the shape of the nanotip. Although electrostatic forces can be overcome at ambient pressure by employing ionizing guns used for electrostatic discharge prevention, such a technique may be difficult in vacuum environments such as those used in photonic quantum computing implementations. One route to minimize the impact of the undesired electromagnetic forces is used double-clamped structures such as that shown in FIG. 1B, which are less compliant and may avoid the attraction by the forces. In addition, mechanical oscillations of the tapered optical fiber may be taken into account in the design. At room temperature and ambient pressure, air damping is quite effective to suppress oscillatory motion, however, at the low pressures used by applications in quantum technologies, techniques to overcome the dynamical mechanical response have not yet been developed. To this end, a buffer gas, such as Helium, may be used to minimize the oscillation amplitude.

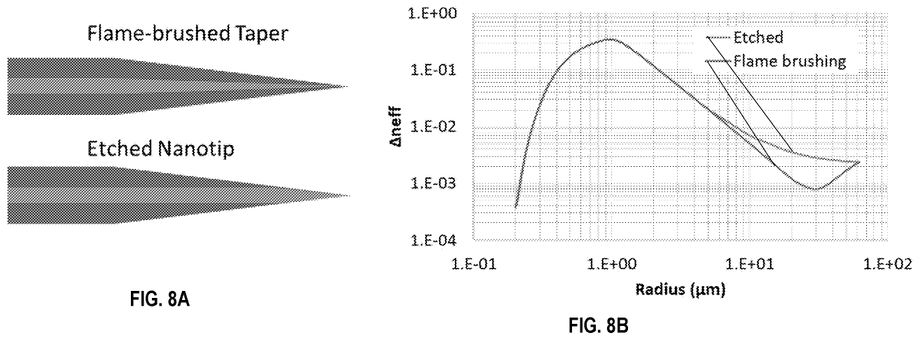

FIG. 8A illustrates cross section views of fiber tips, according to some embodiments. In particular, FIG. 8A illustrates cross section views of a flame-brushed fiber tip as shown in FIG. 1A and an etched nanotip as shown in FIG. 1B. The flame-brushed fiber tip is fabricated by pulling a heated fiber to simultaneously reduce the size of the cladding around the fiber core as well as the core in the transition region. The etched nanotip is chemically etched by removing the cladding and the fiber core. The flame brushing technique creates longer tapers that are limited by the flame size. The chemical etching may be used for batch processing to create multiple fiber tips simultaneously.

Both fiber tips satisfy desired adiabaticity criteria. The adiabaticity criteria used here is determined by the coupling between the core mode and the nearest cladding mode. The taper angle (represented by the derivative of the radius along the taper length) is to satisfy the constraint given by

$$\vert \frac{dr}{dz} \vert \leq r \frac{Δ n}{λ} ,$$

where (Δn) is the difference in effective index between the fundamental and the first cladding mode, and λ is the wavelength of light. The adiabaticity criteria is limited by coupling of the core mode into the first silica cladding mode. Because the effective index of the core mode decreases as with reducing size, eventually being very close to the effective index of the cladding mode, the adiabaticity criteria imposes a relatively slow tapering angle. As etched nanotips are fabricated by etching the silica cladding and slowly pulling the fiber out of the acid solution to form the desired geometry, this leads to the cladding being etched from the start while the core remains unchanged up until close to the end of the process at the point at which the etchant has removed all of the cladding and reaches the core. As such, the effective index of the core and the first cladding mode remain further apart compared to the fiber taper case, resulting in geometries that are more compact.

Solving the modes of the two structures as their geometries evolve allows computing the shortest possible structure that still satisfies the adiabatic criteria. The result is shown in FIG. 8B, plotting the difference in effective index between the fundamental and the first cladding mode for both the taper and the nanotip. In particular, FIG. 8B illustrates the effective index difference between the fundamental and first cladding mode as a function of diameter of the fiber tips shown in FIG. 8A, according to some embodiments. As shown, the flame brushing structure clearly results in smaller index difference.

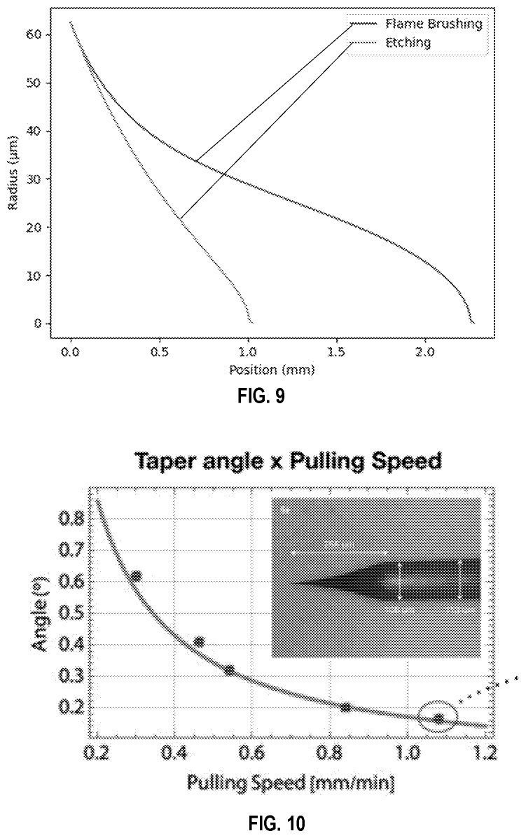

With these, the taper shape that satisfies the adiabatic criteria can be calculated. FIG. 9 illustrates the taper and nanotip profiles limited by the adiabaticity criteria, according to some embodiments. The tapers are very short, having a length of only 1 mm. As below, longer tapers may be used to allow larger mechanical displacements. In other words, the nanotip structure likely will operate well above the adiabatic criteria and therefore radiation loss in the transition region is unlikely.

FIG. 10 illustrates taper measurements, according to some embodiments. The taper measurements are of a nanotip fabricated using a buffered HF solution. FIG. 10 shows the measured taper angle as a function of pulling speed (dots) as the fiber is pulled out of the buffered HF solution. The measured results agree well with the expected curve (solid line). The inset shows a picture of the fabricated nanotip.

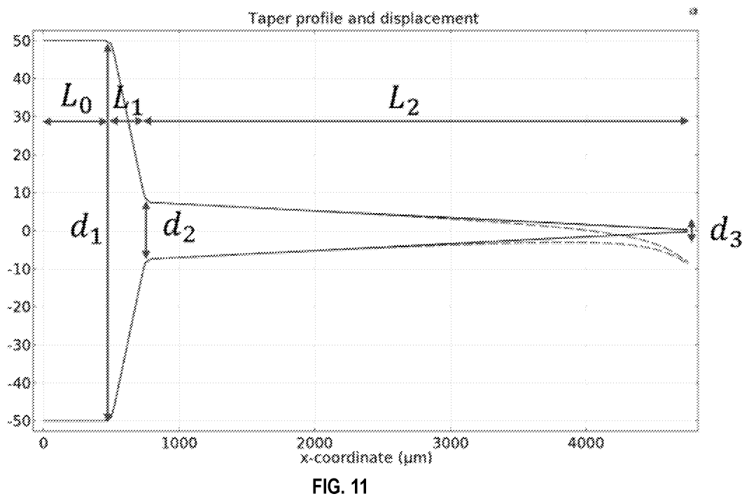

FIG. 11 illustrates taper profile and displacement, according to some embodiments. Small deflections of a beam with varying cross-section along its length can be calculated using the Euler-Bernoulli beam theory. For a given nanotip profile, the goal is to calculate how much deflection is induced as in the presence of the optical force applied at the very end of the tip. An example of deflection is shown by the dashed lines in FIG. 11. The parametrized nanotip profile in FIG. 11 is shown with three regions using a clamped boundary condition on the left. In each region, the diameter of the optical fiber varies linearly from an initial unreduced value to a final reduced value (although as above, the shape may not be linear). The final diameter is fixed by the optical design to d₃=0.5 μm and the initial diameter is the fiber diameter d₁=125 μm, although as elsewhere, these values may vary dependent on the desired design. The length of the fiber prior to the taper L₀ (=125 μm) and the length of the fiber over which cladding is removed L₁ (=125 μm) do not have significant influence in the results as they are kept sufficiently short. This means that the two main physical parameters that are of interest are the initial diameter of the taper d₂ and the length over which the taper occurs L₂, the latter of which is controllable by the speed of drawing the fiber from the heat or etchant. The final diameter may range be as small as about 100 nm.

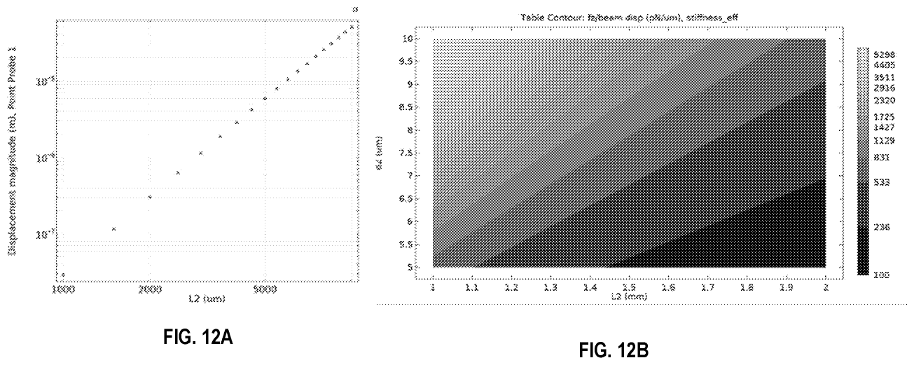

FIGS. 12A and 12B respectively illustrate nanotip deflection and stiffness, according to some embodiments. The displacement varies as a function of parameterization of the nanotip profile with the three linear regions shown in FIG. 11. As shown in FIG. 12A, the displacement varies substantially linearly with the taper length L₂. As shown in FIG. 12B, the stiffness is calculated as a function of the initial diameter of the taper d₂ and the taper length L₂.

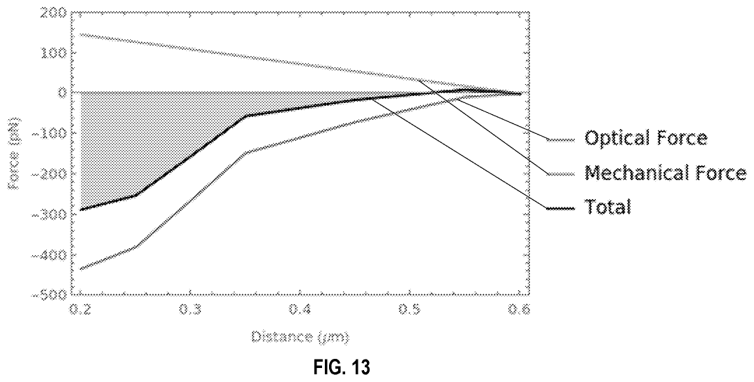

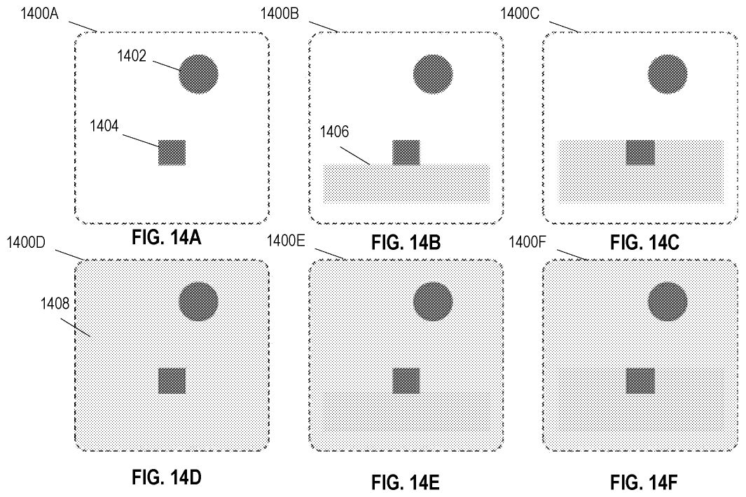

FIG. 13 illustrates optical force, according to some embodiments. Both the optical force and the mechanical force are calculated in FIG. 13 as a function of fiber-to-waveguide distance (shown in FIGS. 5A and 7A). This is used to determine whether the optical force is sufficient to overcome the mechanical stiffness. The graph uses a nanotip with an initial taper diameter d₂=15 μm and a taper length L₂=2.5 mm when an optical laser power of 50 mW is used. The bottom curve of the graph shows the optical force, the top curve shows the restoring mechanical force (linear in nature), and the middle curve is the total force. As can be seen, the total force calculated is attractive over the entire range of distance between the nanotip and the waveguide (up to about 0.6 μm), which indicates that the optical force is larger than the mechanical force over this range.

FIGS. 14A-14F illustrates coupled fiber-waveguide systems, according to some embodiments. Although previous embodiments have used air cladding for both the fiber nanotip and a photonic waveguide, other types of cladding may be used and are shown in the systems 1400A-1400F of FIGS. 14A-14F. FIG. 14A shows a system 1400A that includes an optical fiber 1402 and photonic waveguide 1404 both suspended in air. FIG. 14B shows a system 1400B that includes an optical fiber 1402 and an uncladded waveguide 1404, the latter of which is disposed on a substrate 1406. FIG. 14C shows a system 1400C that includes an optical fiber 1402 and a waveguide 1404 that is embedded in a substrate 1406 such that the sides and bottom of the waveguide 1404 are cladded by the substrate 1406. FIG. 14D shows a system 1400D that includes an optical fiber 1402 and waveguide 1404 both suspended in a low index adhesive material 1408. FIG. 14E shows a system 1400E that includes an optical fiber 1402 and an uncladded waveguide 1404, the latter of which is disposed on a substrate 1406 and both the fiber 1402 and waveguide 1404 are suspended in a low index adhesive material 1408. FIG. 14F shows a system 1400F that includes an optical fiber 1402 and a waveguide 1404 that is embedded in a substrate 1406, with the optical fiber 1402 suspended in a low index adhesive material 1408.

The various systems herein may include a tapered optical fiber with diameter variations from about 1.7 μm to about 0.2 μm, a silicon waveguide with height of about 0.25 μm and varying width from about 0.1 μm to about 0.3 μm, an overlap region between the nanotip and the waveguide taper of about 120 μm where optical forces enable coupling, and operation at telecom wavelengths around 1.55 μm with optical power around 50 mW. The configuration enables specialized applications like quantum computing implementations and operates in controlled environments such as dilution fridges with stable temperature conditions.

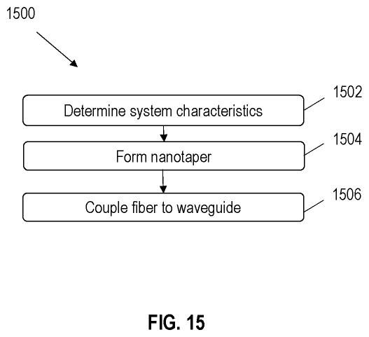

FIG. 15 illustrates a method of fabricating the coupling system, according to some embodiments. Only some operations of the method 1500 are shown; others may be present but are not shown for convenience. Not all of the operations of the method 1500 shown in FIG. 15 may be used.

At operation 1502, the system characteristics are determined using a processor, and based on instructions on a non-transitory computer-readable storage medium. The system characteristics may include the dimensions and shape of the fiber and nanotip and waveguide, as well as the distances between components (optical fiber and waveguide) in the coupling system. The core diameter and length of the nanotip are designed to ensure that the optical forces for light of a predetermined wavelength and power are sufficient to attract the fiber to the waveguide. The length of the nanotip may be as short as possible while being sufficient to achieve the adiabatic condition at the wavelength being used. The nanotip has a final diameter of less than 1 μm. In some embodiments a double-anchored optical fiber taper with a middle section bending towards the waveguide may be used.

Once the system characteristics have been determined, the nanotip may be fabricated at operation 1504. The nanotip may be formed by using a boule that includes, for example, the core and cladding of the fiber, heating the end of the boule and pulling the fiber to simultaneously reduce the size of the core and cladding. Alternatively, the fiber may be disposed in a vat of etchant (such as buffered HF) and pulled out of the etchant to removing the cladding and eventually the core. In both cases, the drawing of the fiber may be performed at a uniform speed to provide a linear nanotip from an initial diameter to a final diameter. In some embodiments, the fiber is partially chemically etched (either without moving the fiber, or moving the fiber much more slowly than during formation of the nanotip) to reduce the initial diameter of the fiber to reach the initial taper diameter prior to forming the nanotip, as shown in FIG. 11.

After forming the nanotip, at operation 1506 the fiber may be coupled to the waveguide. The optical fiber may be positioned near the target waveguide with coarse alignment within 1-2 μm. An initial gap size of around 0.5 μm may be maintained between the nanotip and waveguide. A laser beam of predetermined power may be introduced to one end of the fiber and evanesce from the nanotip. The power may be limited to about 50 mW to ensure that the optical fiber and waveguides are not burned and may be maintained during alignment. The light from the nanotip couples to the waveguide, providing optical forces that attracts the nanotip to the waveguide. The optical forces are generated by radiation pressure from photon momentum transfer and electrostrictive forces from field gradients. The optical fiber mechanically deflects under the optical forces until the system reaches an equilibrium position for optimal coupling.

Once the relative position of the nanotip has stabilized within about 100 nm so that the light couples to the waveguide (i.e., the laser beam is introduced to the fiber for a predetermined amount of time sufficient to stabilize the position), the nanotip may be fixed in place using an epoxy or other low index adhesive material, which is cured by UV radiation and/or thermal means. For example, a UV-curable resin with a refractive index of about 1.3 may be used as the low index adhesive material.

Alternatively, for air-clad systems, the optical power may be maintained until physical contact achieved. At this point, the surface forces may provide sufficient adhesion and/or the low index adhesive material may be applied after alignment.

To verify the alignment, the output power from the waveguide may be monitored to confirm coupling efficiency. Verification may include ensuring that the transmission loss is below about 0.5 dB and operation may be checked across different wavelengths to ensure operation across a 250 nm bandwidth, as well as confirming both TE and TM polarization performance.

Note that in some embodiments, light of different wavelengths (e.g., 1330 nm and 1510 nm) may be used. Although evanescent coupling in shown, in other embodiments, similar principles may be used for end coupling between the nanotip and the waveguide.

Self-alignment via optical forces thus involves simultaneous optimization of the optical and mechanical response of the nanotip, thereby providing optical and mechanical design constraints to be fulfilled by the nanotip. Optically, a low loss nanotip is achieved by ensuring the tapering region is adiabatic, while efficient coupling is achieved by precise control of the tip length and diameter to achieve phase matching with the waveguide coupled to the nanotip. Adiabatic simulations were performed to determine the maximum rate of change of the fiber diameter in the tapering region. This is one limit for any shape of the tapering, exponential, linear, multi-segments, etc. Coupling to the waveguide occurs in about the final 100 μm of the fiber tip, and the geometry at this region were be optimized via 3D FDTD simulations, where both coupling efficiency and optical forces were calculated. The simulations were performed on a linearly tapered Si waveguide with initial width of 100 nm and final width of 350 nm, with height constant at 250 nm. It was found that tapering angle of about 0.35° or less at the about the final 100 μm of the fiber tip was found to be optimal. Furthermore, a straight tip with a diameter of 600 nm was found to further enhance the total optical force generated, while still providing broadband and dual-polarization coupling.

Mechanically, the shape and length of the tapering region determines the mechanical stiffness. A stiffer fiber uses a higher optical force to move, while if the fiber is too compliant the fiber becomes sensitive to perturbations in the environment such as air currents and static, hampering the process. The upper and lower limits to the compliance were first estimated, and then calculations of compliance as a function of taper parameters are presented (herein, the compliance is defined as the displacement of the tip per unit force in units of m/nN).

Considering a tip offset about 0.5 μm from the waveguide, the optical force is approximately 1 pN/mW according to FDTD simulations. In principle, the optical power may be increased to overcome the limitations of weak coupling or high stiffness. However, thermal dissipation can be a concern, depending on whether the system is uncladded (i.e., both the taper and waveguide are suspended in air) or cladded (at least one of the taper or waveguide is at least partially surrounded by a material other than air). It was determined that uncladded systems are more sensitive (given low heat diffusion through air) and therefore the optical power is limited to a maximum of about 100 mW, leading to a maximum optical force of about 100 pN. This translates to a minimum compliance of about 5 μm/nN so that the optical force is sufficient to displace the nanotip and achieve zero offset.

An upper limit to the compliance due to air currents may also be estimated. A typical closed room has an average air current speed of about 10 cm/s and, inside a typical closed testing setup (not hermetically sealed), this value is expected to decrease tenfold. Considering then an average air velocity of about 1 cm/s, the drag equation may be used to estimate the force to which the nanotip is subject due to the air flow:

$${F}_{d} = \frac{ρ {v}^{2} {C}_{d} A}{2}$$

Here, ρ is the air density (about 1.225 kg/m³), C_{d} (0.82) is the drag coefficient, and A is the area, approximated by a cylinder of 1 μm diameter and 500 μm length. This gives a force of about 2 pN. For this force, a compliance higher than about 300 μm/nN allows a displacement of about 0.5 μm due to air flow, and therefore should be set as an upper limit for compliance.

The compliance itself can be calculated from different nanotip geometries, following the Euler-Bernoulli Beam approach. Two profiles were considered, exponential and linear, and the design parameters are the total length, and the final and initial diameters. The exponential profiles are obtained in flame-brushed process, where the initial diameter is about 125 μm (fiber diameter), and the design parameters are then length and final tip diameter. For an HF etching fabrication process, a 2-step etching procedure was employed. In the first etch step, the fiber is kept constant and etched uniformly from about 125 μm diameter to a target value. In the second step, the fiber moves, forming a linear taper shape. The design variables are then the initial diameter for the second step and the length of the linear taper.

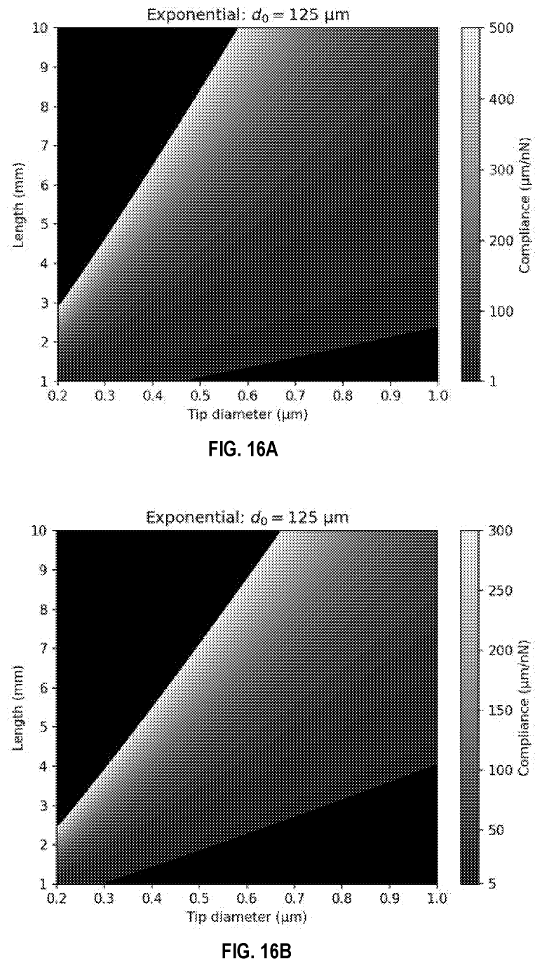

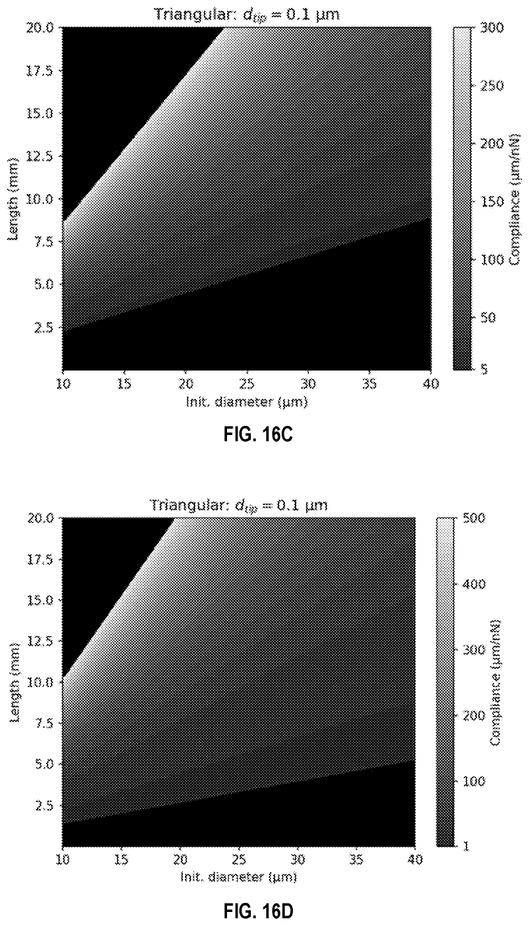

FIGS. 16A and 16B respectively illustrate compliance maps for an exponential nanotip with different compliances, according to some embodiments; FIGS. 16C and 16D respectively illustrate compliance maps for a triangular nanotip different compliances, according to some embodiments. The compliances in FIGS. 16A and 16C extend from about 1 μm/nN to about 500 μm/nN; the compliances in FIGS. 16B and 16D extend from about 5 μm/nN to about 300 μm/nN.

A flame brushed nanotip is an example of an exponential nanotip; the (HF) etched nanotip is an example of a triangular nanotip. The calculated compliance maps shown in FIGS. 16A-16D illustrate linear upper and lower compliance limits respectively of about 1 μm/nN and about 500 μm/nN, and preferably respectively of about 5 μm/nN and about 300 μm/nN. Referring to the above discussion, to provide appropriate characteristics (including adiabaticity, phase matching, and limited length), an exponential nanotip that has an initial diameter of about 125 μm may have a length limited to less than about 15 mm and diameter at the end of the nanotip may be limited to less than about 1.4 μm, and preferably the length may be limited to less than about 10 mm and diameter limited to less than about 1 μm (e.g., for self-alignment under a wider range of ambient conditions). For the triangular nanotip, the length (d₂, shown in FIG. 11) may be limited to less than about 70 mm and, for a nanotip diameter of about 0.1 μm, the initial diameter may be limited to less than about 100 μm and preferably, d₂ may be limited to less than about 20 mm and the initial diameter limited to less than about 40 μm for the same reasons. Note that the same design considerations apply to embodiments in which the taper terminates at an intermediate point and extends in a uniform diameter to the end of the nanotip.

The experiments show that fibers with a compliance near about 50 μm/nN tend to be well balanced. The two-step process (initial etching to reduce the cladding diameter) was not attempted with flame brushed samples in the experiments, though possible.

Typical parameters used to obtain both flame-brushed and HF etched nanotips with the intent of coupling light into a chip fall outside of the region of interest, i.e., the parameters are typically far from the parameters to be obtained herein. In the exponential case, highly adiabatic tapers are usually desired, aiming for longer and (usually) thicker fibers. However, herein it is desired to create short tapers to limit the compliance of the samples, which differs from most applications. One trade-off of this includes decreased adiabaticity.

The HF etched (triangular) case, in which the cladding is reduced then the fiber slowly retracted to form a long tip, unlike other processes in which the Turner method is used. The Turner method removes the multimode fiber cladding from a tip that is as short as possible to enhance the sensitivity of a sensor based on the fiber.

The embodiments herein harness optical forces to control the position of the tapered optical fiber adjacent to, e.g., a photonic waveguide on a chip. Utilizing optical forces mitigate the challenges of alignment precision for evanescent coupling schemes without the use of submicron-scale active control on the fiber positioning. In some embodiments, an optical fiber with a nanotip is brought near to the target photonic waveguide. At close distance, the optical force between the nanotip and the photonic waveguide becomes strong enough to induce self-alignment. In other embodiments, a fiber taper can be anchored at both ends and its middle section bent towards the photonic waveguide. The system used has transmission loss better than about 0.5 dB for two polarizations over a wide band range of over 250 nm at 1.55 μm. In addition, the force between the photonic waveguide and the fiber is attractive, in the range of about 7 pN/mW. Mechanical simulations show that depending on the nanotip shape design, the optical force is sufficient to induce self-alignment for offsets of about 1-2 μm with moderate optical power (50 mW).

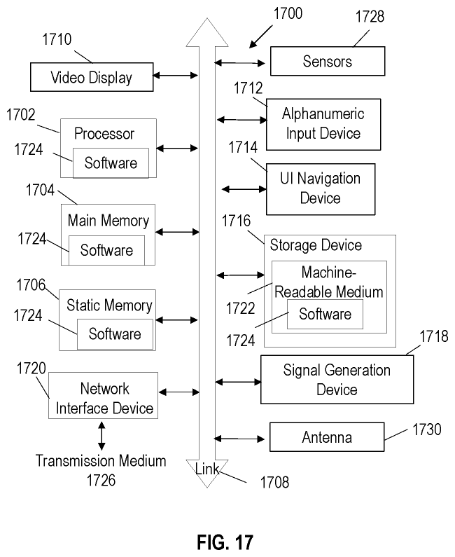

FIG. 17 illustrates a block diagram of an example electronic device, according to some embodiments. The electronic device 1700 may operate as a standalone device or may be connected (e.g., networked) to other devices and may communicate with other devices using the system and process described herein. The electronic device 1700 may be a user equipment (UE) such as a portable communication device or AR/VR device, among others. A portable communication device may include a mobile phone, a smartphone, a laptop computer, a tablet computer, a web appliance, or any machine capable of executing instructions (sequential or otherwise) that specify actions to be taken by that machine. The electronic device 1700 may have additional components not shown in FIG. 17 and/or some of the components shown in FIG. 17 may not be present.

The electronic device 1700 may include a hardware processor 1702 (e.g., a central processing unit (CPU), a graphics processing unit (GPU), a hardware processor core, or any combination thereof), a main memory 1704, and a static memory 1706, some or all of which may communicate with each other via an interlink (e.g., bus) 1708.

Specific examples of main memory 1704 include Random Access Memory (RAM), and semiconductor memory devices, which may include, in some embodiments, storage locations in semiconductors such as registers. Specific examples of static memory 1706 include non-volatile memory, such as semiconductor memory devices (e.g., Electrically Programmable Read-Only Memory (EPROM), Electrically Erasable Programmable Read-Only Memory (EEPROM)) and flash memory devices.

The electronic device 1700 may further include a display device 1710, an input device 1712 (e.g., a keyboard), and a user interface (UI) navigation device 1714 (e.g., a mouse). In an example, the display device 1710, the input device 1712, and the UI navigation device 1714 may be a touch screen display. The electronic device 1700 may additionally include a storage device (e.g., drive unit) 1717, a signal generation device 1718 (e.g., a speaker), a network interface device 1720, one or more antennas 1730, and one or more sensors 1728, such as a global positioning system (GPS) sensor, compass, accelerometer, or other sensors. The electronic device 1700 may include a transmission medium 1726, such as a serial bus (e.g., universal serial bus (USB)), parallel, or other wired or wireless (e.g., infrared (IR), near field communication (NFC), etc.) connection to communicate or control one or more peripheral devices (e.g., a printer, card reader, television). In some embodiments, the hardware processor 1702 and/or instructions 1724 may comprise processing circuitry and/or transceiver circuitry.

The storage device 1717 may include a machine-readable medium 1722 on which is stored one or more sets of data structures or instructions 1724 (e.g., software) embodying or utilized by any one or more of the techniques or functions described herein. The instructions 1724 may also reside, completely or at least partially, within the main memory 1704, within static memory 1706, or the hardware processor 1702 during execution thereof by the electronic device 1700. In an example, one or any combination of the hardware processor 1702, the main memory 1704, the static memory 1706, or the storage device 1717 may constitute machine-readable media.

While the machine-readable medium 1722 is illustrated as a single medium, the term “machine-readable medium” may include a single medium or multiple media (e.g., a centralized or distributed database, and/or associated caches and servers) configured to store instructions 1724. The term “machine-readable medium” may include any medium that is capable of storing, encoding, or carrying instructions for execution by electronic device 1700 and that causes the electronic device 1700 to perform any one or more of the techniques of the present disclosure, or that is capable of storing, encoding or carrying data structures used by or associated with such instructions. Non-limiting machine-readable medium examples may include solid-state memories and optical and magnetic media. Specific examples of machine-readable media may include non-volatile memory, such as semiconductor memory devices (e.g., EPROM or EEPROM) and flash memory devices; magnetic disks, such as internal hard disks and removable disks; magneto-optical disks; RAM; and CD-ROM and DVD-ROM disks.

The instructions 1724 may further be transmitted or received over a communications network using a transmission medium 1726 via the network interface device 1720 utilizing any one of several transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, 3GPP family of standards including Long Term Evolution (LTE) and 17G/5G/6G standards, a Universal Mobile Telecommunications System (UMTS) family of standards, peer-to-peer (P2P) networks, among others.

In an example, the network interface device 1720 may include one or more physical jacks (e.g., Ethernet, coaxial, or phone jacks) or one or more antennas to connect to the communications network. In an example, the network interface device 1720 may include one or more antennas 1730 to wirelessly communicate using at least one of single-input multiple-output (SIMO), multiple-input multiple-output (MIMO), or multiple-input single-output (MISO) techniques. In some examples, the network interface device 1720 may wirelessly communicate using Multiple User MIMO techniques. The term “transmission medium” shall be taken to include any intangible medium that is capable of carrying instructions for execution by the electronic device 1700, which include digital or analog communications signals or other intangible media to facilitate communication of such software.

Examples, as described herein, may include, or may operate on, logic or several components, modules, or mechanisms. Modules are tangible entities (e.g., hardware) capable of performing specified operations and may be configured or arranged in a certain manner. In an example, circuits may be arranged (e.g., internally or concerning external entities such as other circuits) in a specified manner as a module. In an example, the whole or part of one or more computer systems (e.g., a standalone, client, or server computer system) or one or more hardware processors may be configured by firmware or software (e.g., instructions, an application portion, or an application) as a module that operates to perform specified operations. In an example, the software may reside on a machine-readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. The software may accordingly configure a hardware processor, for example, to constitute a particular module at one instance of time and to constitute a different module at a different instance of time.

Some embodiments may be implemented fully or partially in software and/or firmware. This software and/or firmware may take the form of instructions contained in or on a non-transitory computer-readable storage medium. Those instructions may then be read and executed by one or more processors to enable the performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to ROM, RAM, magnetic disk storage media, optical storage media, flash memory, etc.

The hardware processor 1702 may use various circuitry to send and receive communication via the antennas 1730. Although not exclusive, such circuitry may include mixers (such as up- and down-conversion mixer circuitry configured to convert signals between baseband and the transmission frequency), amplifiers configured to amplify signals for communication, filters configured to filter out spurious signals, and drivers to drive the antennas 1730.

### Examples

The following exemplary aspects are provided, the numbering of which is not to be construed as designating levels of importance:

Example 1 is a method of coupling an optical fiber and a waveguide, the method comprising: bringing a nanotip of the optical fiber in proximity to the waveguide; after bringing the nanotip in proximity to the waveguide, introducing a laser beam into the optical fiber; aligning the optical fiber with the waveguide using optical force provided by the laser beam; and after aligning the optical fiber to the waveguide, fixing a relative position of the optical fiber with respect to the waveguide.

In Example 2, the subject matter of Example 1 includes, wherein the optical fiber comprises a first portion that tapers from an initial diameter to a final diameter and a second portion that is shorter than the first portion, and extends from an end of the first portion to an end of the nanotip.

In Example 3, the subject matter of Example 2 includes, wherein the second portion has a uniform diameter.

In Example 4, the subject matter of Examples 2-3 includes, wherein the second portion is tapered.

In Example 5, the subject matter of Examples 2-4 includes, wherein the second portion overlaps the waveguide in a propagation direction of the laser beam.

In Example 6, the subject matter of Example 5 includes, wherein the first portion does not overlap the waveguide in the propagation direction of the laser beam.

In Example 7, the subject matter of Examples 2-6 includes, wherein the second portion overlaps the waveguide in a transverse direction of the laser beam.

In Example 8, the subject matter of Example 7 includes, wherein the first portion does not overlap the waveguide in the transverse direction of the laser beam.

In Example 9, the subject matter of Examples 1-8 includes, wherein a shape of the nanotip of the optical fiber is selected to induce at least a minimum amount of evanescent coupling based on optical loss and adiabatic condition, and dimensions of the nanotip are selected such that the optical force is larger than a stiffness of the nanotip at a predetermined power of the laser beam when introduced to the optical fiber.

In Example 10, the subject matter of Examples 1-9 includes, wherein: the waveguide is tapered, and the nanotip of the optical fiber is aligned to overlap with a taper of the waveguide in a propagation direction of the laser beam.

In Example 11, the subject matter of Examples 1-10 includes, wherein: the optical fiber is configured to taper in diameter over a portion of the optical fiber, and the waveguide is configured to taper in width but not height such that a distance between the waveguide and the optical fiber in a height direction remains substantially identical along a length of the waveguide.

In Example 12, the subject matter of Example 11 includes, wherein an axis of the optical fiber is aligned with an axis of the waveguide.

In Example 13, the subject matter of Examples 1-12 includes, wherein the nanotip is fabricated by heating and pulling the optical fiber to simultaneously reduce a core and silica cladding of the optical fiber in a transition region to a relatively slow tapering angle determined by adiabaticity criteria for coupling a core mode into a first silica cladding mode of the optical fiber.

In Example 14, the subject matter of Examples 1-13 includes, wherein the optical fiber comprises an optical fiber nanotip formed by initially etching cladding of the optical fiber to reduce a diameter of the cladding and subsequently pulling the optical fiber out of an etchant solution to form the nanotip.

In Example 15, the subject matter of Examples 1-14 includes, wherein the nanotip has a first length over which a diameter of the optical fiber reduces linearly at a first rate and a second length over which the diameter of the optical fiber reduces linearly at a second rate, the first length being smaller than the second length.

In Example 16, the subject matter of Examples 11-15 includes, wherein the nanotip has a first diameter, a second diameter after the first length and before the second length, and a third diameter after the second length, a difference between the first diameter and the second diameter being larger than a difference between the second diameter and the third diameter.

In Example 17, the subject matter of Examples 1-16 includes, wherein the waveguide uses air as cladding and is separated from the waveguide by the air.

In Example 18, the subject matter of Examples 1-17 includes, wherein the waveguide uses low index material as cladding and is separated from a silicon substrate by the low index material.

In Example 19, the subject matter of Examples 1-18 includes, wherein the optical fiber is fixed to the waveguide using a low index adhesive material.

In Example 20, the subject matter of Examples 1-19 includes, wherein: the nanotip has a compliance bounded by linear upper and lower compliance limits respectively of about 1 μm/nN and about 500 μm/nN, for an exponential nanotip that has an initial diameter of about 125 μm, a length of the nanotip is limited to less than about 15 mm and a diameter at the end of the nanotip is limited to less than about 1.4 μm, and for a triangular nanotip with a final diameter of about 0.1 μm, a length of the nanotip is limited to less than about 70 mm and an initial diameter is limited to less than about 100 μm.

In Example 21, the subject matter of Example 20 includes, wherein: the length of the exponential nanotip is limited to less than about 10 mm and the diameter is limited to less than about 1 μm, and the length of the triangular nanotip is limited to less than about 20 mm and the diameter is limited to less than about 40 μm.

In Example 22, the subject matter of Examples 20-21 includes, wherein the compliance is bounded by linear upper and lower compliance limits respectively of about 5 μm/nN and about 300 μm/nN.

Example 23 is an optical fiber comprising a core and cladding, the optical fiber having a nanotip, the nanotip having a shape selected to induce evanescent coupling between the optical fiber and a waveguide based on optical loss and adiabatic condition and a stiffness selected to be low enough to be insufficient to balance an optical force from attracting the nanotip to the waveguide during evanescent coupling at a predetermined laser beam power introduced into the optical fiber, the optical loss being less than about 1 dB.

In Example 24, the subject matter of Example 23 includes, wherein the nanotip has a first length over which a diameter of the optical fiber reduces linearly at a first rate and a second length over which the diameter of the optical fiber reduces linearly at a second rate, the first length being smaller than the second length.

In Example 25, the subject matter of Example 24 includes, wherein the nanotip has a first diameter, a second diameter after the first length and before the second length, and a third diameter after the second length, a difference between the first diameter and the second diameter being larger than a difference between the second diameter and the third diameter.

In Example 26, the subject matter of Examples 23-25 includes, wherein the nanotip has a flame-brushed structure in which the core and cladding of the optical fiber is simultaneously reduced in a transition region to a relatively slow tapering angle determined by adiabaticity criteria for coupling a core mode into a first cladding mode of the optical fiber.

In Example 27, the subject matter of Examples 23-26 includes, wherein the optical fiber comprises an etched optical fiber nanotip in which the cladding is etched along an entirety of the nanotip and the core of the optical fiber is unchanged until close to an end of the nanotip.

Example 28 is an optical system comprising: a waveguide; an optical fiber having a nanotip, the nanotip having a first length over which a diameter of the optical fiber reduces linearly at a first rate and a second length over which the diameter of the optical fiber reduces linearly at a second rate, the second length being larger than the first length such that the second length satisfies adiabatic conditions and having a stiffness selected to be low enough to be insufficient to balance an optical force from attracting the nanotip to the waveguide during evanescent coupling at a predetermined laser beam power introduced into the optical fiber; and a low index adhesive material fixing the optical fiber to the waveguide.

Example 29 is at least one machine-readable medium including instructions that, when executed by processing circuitry, cause the processing circuitry to perform operations to implement of any of Examples 1-28.

Example 30 is an apparatus comprising means to implement of any of Examples 1-28.

Example 31 is a system to implement of any of Examples 1-28.

Example 32 is a method to implement of any of Examples 1-28.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In the methods described herein, the acts can be carried out in a specific order as recited herein. Alternatively, in any aspect(s) disclosed herein, specific acts may be carried out in any order without departing from the principles of the invention, except when a temporal or operational sequence is explicitly recited. Furthermore, specified acts can be carried out concurrently unless explicit claim language recites that they be carried out separately or the plain meaning of the claims would require it. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%. The term “substantially free of” as used herein can mean having none or having a trivial amount of, such that the amount of material present does not affect the material properties of the composition including the material, such that about 0 wt % to about 5 wt % of the composition is the material, or about 0 wt % to about 1 wt %, or about 5 wt % or less, or less than, equal to, or greater than about 4.5 wt %, 4, 3.5, 3, 2.5, 2, 1.5, 1, 0.9, 0.8, 0.7, 0.6, 0.5, 0.4, 0.3, 0.2, 0.1, 0.01, or about 0.001 wt % or less, or about 0 wt %.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. A method of coupling an optical fiber and a waveguide, the method comprising:
bringing a nanotip of the optical fiber in proximity to the waveguide;
after bringing the nanotip in proximity to the waveguide, introducing a laser beam into the optical fiber;
aligning the optical fiber with the waveguide using optical force provided by the laser beam; and
after aligning the optical fiber to the waveguide, fixing a relative position of the optical fiber with respect to the waveguide.

2. The method of claim 1 wherein the optical fiber comprises a first portion that tapers from an initial diameter to a final diameter and a second portion that is shorter than the first portion, and extends from an end of the first portion to an end of the nanotip.

3. The method of claim 2 wherein the second portion has a uniform diameter.

4. The method of claim 2 wherein the second portion is tapered.

5. The method of claim 2 wherein the second portion overlaps the waveguide in a propagation direction of the laser beam.

6. The method of claim 5 wherein the first portion does not overlap the waveguide in the propagation direction of the laser beam.

7. The method of claim 2 wherein the second portion overlaps the waveguide in a transverse direction of the laser beam.

8. The method of claim 7 wherein the first portion does not overlap the waveguide in the transverse direction of the laser beam.

9. The method of claim 1 wherein a shape of the nanotip of the optical fiber is selected to induce at least a minimum amount of evanescent coupling based on optical loss and adiabatic condition, and dimensions of the nanotip are selected such that the optical force is larger than a stiffness of the nanotip at a predetermined power of the laser beam when introduced to the optical fiber.

10. The method of claim 1 wherein:
the waveguide is tapered, and
the nanotip of the optical fiber is aligned to overlap with a taper of the waveguide in a propagation direction of the laser beam.

11. The method of claim 1 wherein:
the optical fiber is configured to taper in diameter over a portion of the optical fiber, and
the waveguide is configured to taper in width but not height such that a distance between the waveguide and the optical fiber in a height direction remains substantially identical along a length of the waveguide.

12. The method of claim 11 wherein an axis of the optical fiber is aligned with an axis of the waveguide.

13. The method of claim 1 wherein the nanotip is fabricated by heating and pulling the optical fiber to simultaneously reduce a core and silica cladding of the optical fiber in a transition region to a relatively slow tapering angle determined by adiabaticity criteria for coupling a core mode into a first silica cladding mode of the optical fiber.

14. The method of claim 1 wherein the optical fiber comprises an optical fiber nanotip formed by initially etching cladding of the optical fiber to reduce a diameter of the cladding and subsequently pulling the optical fiber out of an etchant solution to form the nanotip.

15. The method of claim 1 wherein the nanotip has a first length over which a diameter of the optical fiber reduces linearly at a first rate and a second length over which the diameter of the optical fiber reduces linearly at a second rate, the first length being smaller than the second length.

16. The method of claim 11 wherein the nanotip has a first diameter, a second diameter after the first length and before the second length, and a third diameter after the second length, a difference between the first diameter and the second diameter being larger than a difference between the second diameter and the third diameter.

17. The method of claim 1 wherein the waveguide uses air as cladding and is separated from the waveguide by the air.

18. The method of claim 1 wherein the waveguide uses low index material as cladding and is separated from a silicon substrate by the low index material.

19. The method of claim 1 wherein the optical fiber is fixed to the waveguide using a low index adhesive material.

20. The method of claim 1 wherein:
the nanotip has a compliance bounded by linear upper and lower compliance limits respectively of about 1 μm/nN and about 500 μm/nN,
for an exponential nanotip that has an initial diameter of about 125 μm, a length of the nanotip is limited to less than about 15 mm and a diameter at the end of the nanotip is limited to less than about 1.4 μm, and
for a triangular nanotip with a final diameter of about 0.1 μm, a length of the nanotip is limited to less than about 70 mm and an initial diameter is limited to less than about 100 μm.

21. The method of claim 20 wherein:
the length of the exponential nanotip is limited to less than about 10 mm and the diameter is limited to less than about 1 μm, and
the length of the triangular nanotip is limited to less than about 20 mm and the diameter is limited to less than about 40 μm.

22. The method of claim 20 wherein the compliance is bounded by linear upper and lower compliance limits respectively of about 5 μm/nN and about 300 μm/nN.

23. An optical fiber comprising a core and cladding, the optical fiber having a nanotip, the nanotip having a shape selected to induce evanescent coupling between the optical fiber and a waveguide based on optical loss and adiabatic condition and a stiffness selected to be low enough to be insufficient to balance an optical force from attracting the nanotip to the waveguide during evanescent coupling at a predetermined laser beam power introduced into the optical fiber, the optical loss being less than about 1 dB.

24. The optical fiber of claim 23 wherein the nanotip has a first length over which a diameter of the optical fiber reduces linearly at a first rate and a second length over which the diameter of the optical fiber reduces linearly at a second rate, the first length being smaller than the second length.

25. The optical fiber of claim 24 wherein the nanotip has a first diameter, a second diameter after the first length and before the second length, and a third diameter after the second length, a difference between the first diameter and the second diameter being larger than a difference between the second diameter and the third diameter.

26. The optical fiber of claim 23 wherein the nanotip has a flame-brushed structure in which the core and cladding of the optical fiber is simultaneously reduced in a transition region to a relatively slow tapering angle determined by adiabaticity criteria for coupling a core mode into a first cladding mode of the optical fiber.

27. The optical fiber of claim 23 wherein the optical fiber comprises an etched optical fiber nanotip in which the cladding is etched along an entirety of the nanotip and the core of the optical fiber is unchanged until close to an end of the nanotip.

28. An optical system comprising:
a waveguide;
an optical fiber having a nanotip, the nanotip having a first length over which a diameter of the optical fiber reduces linearly at a first rate and a second length over which the diameter of the optical fiber reduces linearly at a second rate, the second length being larger than the first length such that the second length satisfies adiabatic conditions and having a stiffness selected to be low enough to be insufficient to balance an optical force from attracting the nanotip to the waveguide during evanescent coupling at a predetermined laser beam power introduced into the optical fiber; and
a low index adhesive material fixing the optical fiber to the waveguide.
